(19) United States
(12) Patent Application Publication
(10) Pub. No.: US 2024/0087164 A1
(43) Pub. Date: Mar. 14, 2024

(54) ELECTROLUMINESCENT REFERENCE FIDUCIAL AND SYSTEM THEREFOR

(71) Applicant: Rockwell Collins, Inc., Cedar Rapids, IA (US)

(72) Inventors: Elizabeth A. Herman, Troy, NY (US); Carlo L. Tiana, Goldendale, WA (US)

(21) Appl. No.: 18/517,267

(22) Filed: Nov. 22, 2023

Related U.S. Application Data
(63) Continuation-in-part of application No. 18/108,967, filed on Feb. 13, 2023.
Application No. 18/108,967 is a continuation-in-part of application No. 17/849,134, filed on Jun. 24, 2022, now Pat. No. 11,768,374.

(51) Int. Cl. G06T 7/73; G06F 1/16; G06K 7/10; G06K 7/14

(52) U.S. Cl. CPC G06T 7/74; G06F 1/163; G06K 7/10722; G06K 7/1417

(57) ABSTRACT

A system includes reference fiducials including an electroluminescent reference fiducial(s). The system may further include a head wearable display (HWD) device. The system may further include optical sensor(s) configured to: capture images of one or more of the electroluminescent reference fiducial(s). The system may further include processor(s). At least one of the processor(s) may be implemented in and/or on the HWD device. The processor(s) may be configured to: receive data from the optical sensor(s); and based at least on the data, determine a position and orientation of the HWD device. The display may be configured to display images aligned with the field of view of the user based at least on the determined position and the determined orientation of the HWD device.

### CROSS-REFERENCE TO RELATED APPLICATIONS

The instant application is related to and claims the benefit of the earliest available effective filing dates as a continuation in part of the following U. S. Patent Applications:
(1) U.S. patent application Ser. No. 18/108,967, filed Feb. 13, 2023, which claims the benefit, as a continuation in part, of:
   (a) U.S. patent application Ser. No. 17/849,134, filed Jun. 24, 2022, issued as U.S. Pat. No. 11,768,374 on Sep. 26, 2023;
each of which is incorporated by reference in its entirety.

### BACKGROUND

Head tracking is used for head wearable display (HWD) devices and head up displays to maintain conformality with the real world and to also provide input for changing or blanking the display based on head pose configurations. Head tracking systems often use inertial tracking and/or optical tracking of the head and/or pose of a user. Currently, optical tracking uses either inside-out or outside-in tracking. Outside-in and inside-out tracking typically require precise installation and alignment of sensors and/or targets in cockpits, and likely include cockpit mapping, and such installed sensors and/or targets can be distracting to the pilot.

Currently, Quick Response (QR) codes, also referred to as ArUco markers, are sometimes used as fiducial features in the cockpit to precisely locate a pilot's head and viewing direction for navigation and information relay. Currently, the codes are printed on an opaque sticker which limits the pilot's field of view when applied to the windows or on display screens.

### SUMMARY

In one aspect, embodiments of the inventive concepts disclosed herein are directed to a system. The system includes reference fiducials. Each of the reference fiducials may be located at a different location within an environment. Each of at least one of the reference fiducials may be at least one electroluminescent reference fiducial. The system may further include a head wearable display device configured to be worn by a user. The head wearable display device may include a display configured to display images aligned with a field of view of the user. The system may include at least one optical sensor configured to: capture images of one or more of the at least one electroluminescent reference fiducial; and output optical sensor image data corresponding to the captured images. The one or more of the at least one electroluminescent reference fiducial may be located on at least one of at least one exterior surface of the head wearable display device within the environment or on at least one surface within the environment, each of the at least one surface not being one of the at least one exterior surface of the head wearable display device. The one or more of the at least one optical sensor may be located in, within, and/or on at least one of the head wearable display device within the environment or one or more surfaces within the environment, each of the one or more surfaces not being one of the at least one exterior surface of the head wearable display device. The system may further include at least one processor. One or more of the at least one processor may be communicatively coupled to the at least one optical sensor. The at least one of the at least one processor may be implemented in and/or on the head wearable display device. The at least one processor may be configured to: receive the optical sensor image data; and based at least on the optical sensor image data, determine a position and orientation of the head wearable display device. The display may be configured to display the images aligned with the field of view of the user based at least on the determined position and the determined orientation of the head wearable display device.

In a further aspect, embodiments of the inventive concepts disclosed herein are directed to an electroluminescent reference fiducial. The electroluminescent reference fiducial may include at least one electroluminescent ink and at least one piezoelectric energy harvester configured to provide at least one alternating current (AC) to power electroluminescence of each of the at least one electroluminescent ink.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a view of an exemplary embodiment of a system including a head wearable display (HWD) device according to the inventive concepts disclosed herein.

FIG. 2 is a view of the head and/or pose tracking system of the HWD device of FIG. 1 according to the inventive concepts disclosed herein.

FIG. 3 is a view of the head and/or pose tracking system of the computing device of FIG. 1 according to the inventive concepts disclosed herein.

FIG. 4 is a view of the enhanced vision system of the system of FIG. 1 according to the inventive concepts disclosed herein.

FIG. 5A is a view of an exemplary embodiment of the aircraft cockpit of FIG. 1 according to the inventive concepts disclosed herein.

FIG. 5B is a view of an exemplary embodiment of the aircraft cockpit of FIG. 1 according to the inventive concepts disclosed herein.

FIG. 6 is a view of an exemplary embodiment of an imperceptible cockpit reference fiducial of FIG. 2, 5A, or 5B according to the inventive concepts disclosed herein.

FIGS. 7A, 7B, 7C, 7D, and 7E are views of exemplary embodiments of imperceptible cockpit reference fiducials of FIG. 2 or 5A according to the inventive concepts disclosed herein.

FIG. 8 is a diagram of an exemplary embodiment of a method according to the inventive concepts disclosed herein.

FIG. 9 is a view of exemplary embodiment of a transparent quick response (QR) code according to the inventive concepts disclosed herein.

FIG. 10 is a view of an exemplary embodiment having an exemplary environment and the system of FIG. 1 including exemplary electroluminescent reference fiducials according to the inventive concepts disclosed herein.

FIGS. 11A, 11B, 11C, 11D, 11E, 11F, 11G, and 11H are views of exemplary embodiments of electroluminescent reference fiducials of FIG. 10 according to the inventive concepts disclosed herein.

FIG. 12 is a view of an exemplary embodiment of an electroluminescent reference fiducial of FIGS. 10-11H according to the inventive concepts disclosed herein

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a method, an electroluminescent reference fiducial, and a system including at least one electroluminescent reference fiducial, which may be used for head and/or pose tracking of a head wearable display (HWD) device.

Some embodiments include outside-in head and/or pose tracking objects (e.g., imperceptible reference fiducials, such as imperceptible cockpit reference fiducials) in a vehicle (e.g., aircraft) structure, wherein the imperceptible reference fiducials absorb, emit, and/or reflect ultraviolet (UV), short-wave infrared (SWIR), infrared (IR) and/or near infrared (NIR) light. For example, the imperceptible reference fiducials could be positioned at various locations within an aircraft cockpit, such as on a ceiling, on an avionics console, on an overhead switch panel, or displayed by a head-down display(s) (HDD), or the like. The imperceptible reference fiducials may be invisible to the naked eye of a user, but would be apparent and trackable by an optical sensor configured to capture light in the invisible spectrum.

Some embodiments may include interlacing (e.g., intermittently interlacing) imperceptible reference fiducials within frames displayed by at least one display (e.g., a head-down display (HDD)). In some embodiments, the imperceptible reference fiducials may include a pattern that represents a head tracking code that can indicate a specific location of the fiducial to the head and/or pose tracking system. The interlaced frames having the imperceptible reference fiducials may be synchronized with the head and/or pose tracking system (e.g., upon startup of the HWD device and/or HDD). In some embodiments, the interlaced frames having the imperceptible reference fiducials may be displayed in the visible spectrum, but be displayed so infrequently that the imperceptible reference fiducials are imperceptible to humans. In some embodiments, the frames having the imperceptible reference fiducials may be displayed in an invisible spectrum (e.g., the ultraviolet (UV), infrared (IR), short-wave infrared (SWIR), and/or near infrared (NIR) spectrum) such that the imperceptible reference fiducials are invisible to humans, but capturable by an optical sensor configured to capture light in the invisible spectrum (e.g., the ultraviolet (UV), IR, short-wave infrared (SWIR), and/or NIR spectrum). In some embodiments, the HDDs may display multiple unique patterns for the imperceptible reference fiducials to improve head and/or pose tracking accuracy.

Some embodiments including the imperceptible reference fiducials may reduce installation time and cost, reduce maintenance, and improve an aesthetic of the cockpit as compared to other fiducials, which may improve pilot and original equipment manufacturer (OEM) acceptability. Additionally, the imperceptible reference fiducials may reduce pilot distraction when looking around the cockpit.

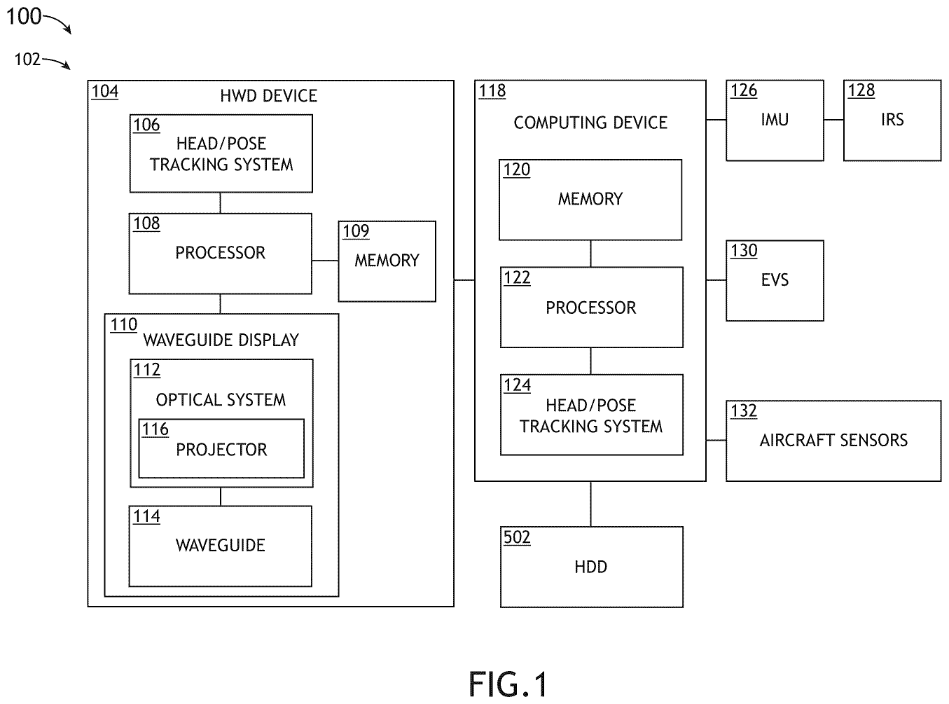

Referring now to FIGS. 1, 2, 3, 4, 5A, 5B, 6, 7A, 7B, 7C, 7D, and 7E an exemplary embodiment of a system according to the inventive concepts disclosed herein is depicted. The system may be implemented as any suitable system, such as at least one vehicle (e.g., an aircraft 100, a spacecraft, an automobile, a watercraft, a submarine, or a train). For example, as shown in FIG. 1, the system may include an aircraft 100. For example, the vehicle (e.g., the aircraft 100 or automobile) may include a cockpit (e.g., an aircraft cockpit 102 or an automobile cockpit). For example, aircraft 100 and/or the aircraft cockpit 102 may include at least one HWD device 104, at least one computing device 118, at least one inertial measurement unit (IMU) 126, at least one inertial reference system (IRS) 128, at least one enhanced vision system (EVS) 130, at least one HDD 502, and/or aircraft sensors 132, some or all of which may be communicatively coupled at any given time.

In some embodiments, the HWD device 104 may include at least one head and/or pose tracking system 106, at least one processor 108, at least one memory 109, and/or at least one display (e.g., at least one waveguide display 110, at least one light emitting diode (LED) display, and/or at least one liquid crystal display (LCD)), some or all of which may be optically and/or communicatively coupled at any given time. For example, the waveguide display 110 may include at least one optical system 112, and/or at least one waveguide 114, some or all of which may be optically and/or communicatively coupled at any given time. In some embodiments, the HWD device 104 may be in the aircraft cockpit 102.

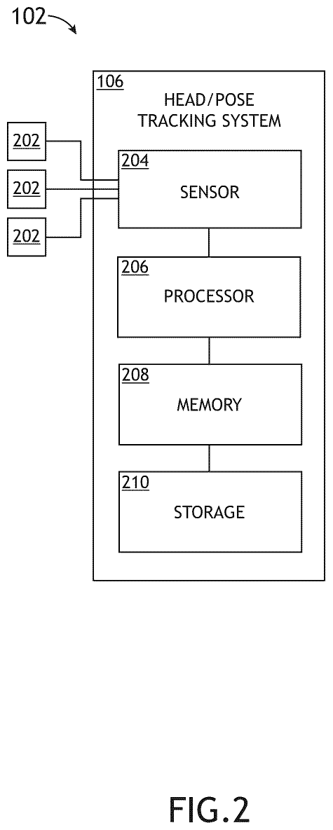

The head and/or pose tracking system 106 may have optical, magnetic, and/or inertial tracking capability. In some embodiments, the head and/or pose tracking system 106 may include head and/or pose tracking capabilities and/or be coordinated with head and/or pose tracking capabilities of another head and/or pose tracking system (e.g., 124), for example, such that the head and/or pose tracking operations are relative to a position and/or orientation of a user and/or relative to a position and/or orientation to a vehicle (e.g., the aircraft 100). For example, the head and/or pose tracking system 106 may be configured to track a direction of where a field of view (FOV) through the waveguide display 110 is pointing. For example, if the waveguide display 110 is mounted to the HWD device 104, this direction may be a direction that a head is pointing that is being tracked. The head and/or pose tracking system 106 may include at least one sensor 204 (e.g., an UV, SWIR, IR and/or NIR camera configured to capture images of imperceptible cockpit reference fiducials 202) and/or output optical sensor image data, at least one processor 206, at least one memory 208, and/or at least one storage device 210, as well as other components, equipment, and/or devices commonly included in a head and/or pose tracking system, some or all of which may be communicatively coupled at any time, as shown in FIG. 2. The at least one processor 206 may be implemented as any suitable processor(s), such as at least one general purpose processor, at least one central processing unit (CPU), at least one image processor, at least one graphics processing unit (GPU), at least one field-programmable gate array (FPGA), and/or at least one special purpose processor configured to execute instructions for performing (e.g., collectively performing if more than one processor) any or all of the operations disclosed throughout. The at least one sensor 204 may be at least one optical sensor (e.g., an optical UV, SWIR, IR, and/or NIR sensor (e.g., an UV, SWIR, IR, and/or NIR camera) configured to detect UV, SWIR, IR, and/or NIR light emitted and/or reflected from the imperceptible cockpit reference fiducials 202), at least one magnetic sensor, and/or at least one inertial sensor. The head and/or pose tracking system 106 may be configured to determine and track a position and an orientation of a user's head relative to an environment (e.g., a cockpit 102). The head and/or pose tracking system 106 may be configured for performing fully automatic head and/or pose tracking operations in real time. The processor 206 of the head and/or pose tracking system 106 may be configured to process data received from the sensors 204 and output processed data (e.g., head and/or pose tracking data) to one of the computing devices of the system and/or the processor 108 for use in generating images aligned with the user's field of view, such as augmented reality or virtual reality images aligned with the user's field of view to be displayed by the waveguide display 110. For example, the processor 206 may be configured to: receive the optical sensor image data; based at least on the optical sensor image data, determine a position and orientation of the head wearable display device; and/or determine and track a position and orientation of a user's head relative to an environment (e.g., a cockpit 102). Additionally, for example, the processor 206 may be configured to: generate position and orientation data associated with such determined information and output the generated position and orientation data. The processor 206 may be configured to run various software applications or computer code stored in a non-transitory computer-readable medium (e.g., memory 208 and/or storage device 210) and configured to execute various instructions or operations. In some embodiments, the at least one processor 206 may be implemented as a special purpose processor configured to execute instructions for performing (e.g., collectively performing if more than one processor) any or all of the operations disclosed throughout.

The at least one processor 108 may be implemented as any suitable processor(s), such as at least one general purpose processor, at least one central processing unit (CPU), at least one image processor, at least one graphics processing unit (GPU), and/or at least one special purpose processor configured to execute instructions for performing (e.g., collectively performing if more than one processor) any or all of the operations disclosed throughout. In some embodiments, the processor 108 may be communicatively coupled to the waveguide display 110. For example, the processor 108 may be configured to: receive head and/or pose system tracking data; receive image data from the computing device 118; generate and/or output image data to the waveguide display 110 and/or to the optical system 112, for example, based on the head and/or pose tracking system data; generate and/or output augmented reality and/or virtual reality image data to waveguide display 110 and/or the optical system 112, for example, based on the head and/or pose tracking system data; and/or generate and/or output other image data, which may include vehicle operation (e.g., aircraft) information, symbology, navigation information, tactical information, and/or sensor information to the waveguide display 110 and/or the optical system 112, for example, based on the head and/or pose tracking system data.

The waveguide display 110 may be implemented as any suitable waveguide display. For example, the waveguide display 110 may be configured to: display the images aligned with the field of view of the user based at least on the determined position and the determined orientation of the head wearable display device. The waveguide display 110 may be implemented in or on the head wearable display device 104. The waveguide display 110 may include the at least one optical system 112 and/or at least one waveguide 114. For example, the optical system 112 may include at least one processor, at least one collimator, and/or at least projector 116. The optical system 112 may be configured to: receive image data corresponding to an image; and/or project images at least through the waveguide 114 to be displayed to the user. In some embodiments, the waveguide 116 may be a diffractive, mirror, or beam splitter based waveguide. In some embodiments, the waveguide display 111 may include at least one lens, at least one mirror, diffraction gratings, at least one polarization sensitive component, at least one beam splitter, the at least one waveguide 114, at least one light pipe, at least one window, and/or the projector 116.

The optical system 112 may be configured to receive image data from the processor 108 and project images through the waveguide 114 for display to the user.

In some embodiments, the head wearable display device 104 may include a second waveguide display 110 including a second waveguide 114 and a second optical system 112, wherein the second optical system 112 is configured to: receive the image data corresponding to the image and project the image at least through the second waveguide to be displayed to the user. In some embodiments, the waveguide display 110 is one of a left eye waveguide display or a right eye waveguide display, wherein the second waveguide display 110 is another of the left eye waveguide display or the right eye waveguide display.

The computing device 118 may be implemented as any suitable computing device, such as an avionics computing device. The computing device 118 may include at least one memory 120, at least one processor 122, and/or at least one head and/or pose tracking system 124, some or all of which may be communicatively coupled at any given time.

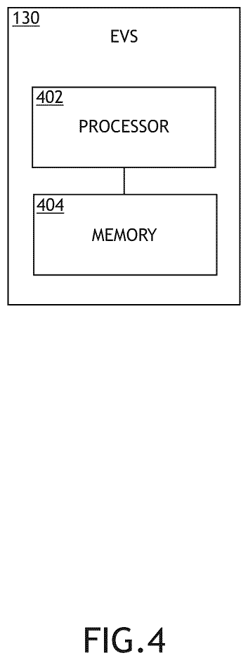

The at least one processor 122 may be implemented as any suitable processor(s), such as at least one general purpose processor, at least one central processing unit (CPU), at least one FPGA, at least one image processor, at least one graphics processing unit (GPU), and/or at least one special purpose processor configured to execute instructions for performing (e.g., collectively performing if more than one processor) any or all of the operations disclosed throughout. For example, the processor 122 may be configured to: receive IMU data from the IMU 126 and/or IRS data from the IRS 128; receive EVS image data from the EVS 130 (which may include at least one processor 402 and at least one memory 404 as shown in FIG. 4); and/or receive aircraft sensor data from the aircraft sensors 132; receive head and/or pose system tracking data; generate and/or output image data to the waveguide display 110 and/or to the optical system 112, for example, based on the head and/or pose tracking system data; generate and/or output augmented reality and/or virtual reality image data to waveguide display 110 and/or the optical system 112, for example, based on and/or the head and/or pose tracking system data; and/or generate and/or output other image data, which may include vehicle operation (e.g., aircraft) information, symbology, navigation information, tactical information, and/or sensor information to the waveguide display 110 and/or the optical system 112, for example, based on the head and/or pose tracking system data.

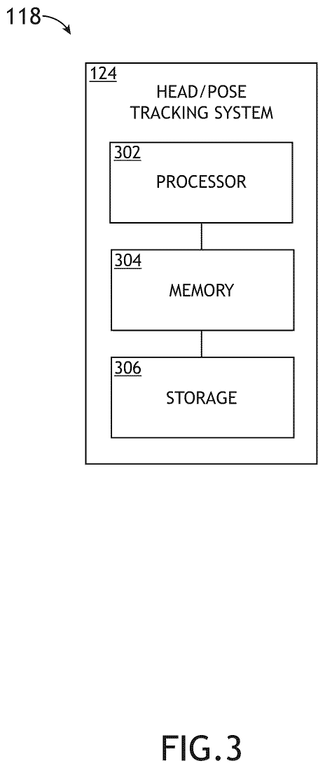

The head and/or pose tracking system 124 may have optical, magnetic, and/or inertial tracking capability. In some embodiments, the head and/or pose tracking system 124 may include head and/or pose tracking capabilities and/or be coordinated with head and/or pose tracking capabilities of another head and/or pose tracking system (e.g., 106), for example, such that the head and/or pose tracking operations are relative to a position and/or orientation of a user and/or relative to a position and/or orientation to a vehicle (e.g., the aircraft 100). For example, the head and/or pose tracking system 124 may be configured to track a direction of where a field of view (FOV) through the waveguide display 110 is pointing. For example, if the waveguide display 110 is mounted to the HWD device 104, this direction may be a direction that a head is pointing that is being tracked. The head and/or pose tracking system 106 may include at least one sensor (not shown), at least one processor 302, at least one memory 306, and/or at least one storage device 308, as well as other components, equipment, and/or devices commonly included in a head and/or pose tracking system, some or all of which may be communicatively coupled at any time, as shown in FIG. 3. The at least one processor 302 may be implemented as any suitable processor(s), such as at least one general purpose processor, at least one central processing unit (CPU), at least one image processor, at least one graphics processing unit (GPU), at least one field-programmable gate array (FPGA), and/or at least one special purpose processor configured to execute instructions for performing (e.g., collectively performing if more than one processor) any or all of the operations disclosed throughout. The at least one sensor may be at least one optical sensor (e.g., an optical UV, SWIR, IR, and/or NIR sensor (e.g., an UV, SWIR, IR, and/or NIR camera) configured to detect UV, SWIR, IR, and/or NIR light emitted and/or reflected from the fiducials 202), at least one magnetic sensor, and/or at least one inertial sensor. The head and/or pose tracking system 124 may be configured to determine and track a position and an orientation of a user's head relative to an environment (e.g., a cockpit 102). The head and/or pose tracking system 124 may be configured for performing fully automatic head and/or pose tracking operations in real time. The processor 302 of the head and/or pose tracking system 124 may be configured to process data received from the sensors 204 and output processed data (e.g., head and/or pose tracking data) to one of the computing devices of the system and/or the at least one processor (e.g., 108, 206, and/or 122) for use in generating images aligned with the user's field of view, such as augmented reality or virtual reality images aligned with the user's field of view to be displayed by the waveguide display 110. For example, the processor 302 may be configured to: determine and track a position and orientation of a user's head relative to an environment (e.g., a cockpit 102). The processor 302 may be configured to receive IMU data from the IMU 126 and/or IRS data from the IRS 128. Additionally, for example, the processor 302 may be configured to generate position and orientation data associated with such determined information and output the generated position and orientation data. The processor 302 may be configured to run various software applications or computer code stored in a non-transitory computer-readable medium (e.g., memory 304 and/or storage device 306) and configured to execute various instructions or operations. In some embodiments, the at least one processor 302 may be implemented as a special purpose processor configured to execute instructions for performing (e.g., collectively performing if more than one processor) any or all of the operations disclosed throughout.

In some embodiments, at least one processor (e.g., 108 and/or 122), each of the at least one processor (e.g., at least one processor 108, at least one processor 206, at least one processor 302, and/or at least one processor 122) implemented in the head wearable display device 104 or in a computing device 118 separate from the head wearable display device 104, wherein the at least one processor (e.g., 108 and/or 122) is configured to perform (e.g., collectively configured to perform, if more than one processor) any of the operations disclosed throughout. For example, the at least one processor may be at least four processors including at least one head wearable display device processor 108, at least one at least one computing device processor 122, at least one head and/or pose tracking system processor 206, and/or at least one head and/or pose tracking system processor 302 collectively configured to perform any or all of the operations disclosed throughout.

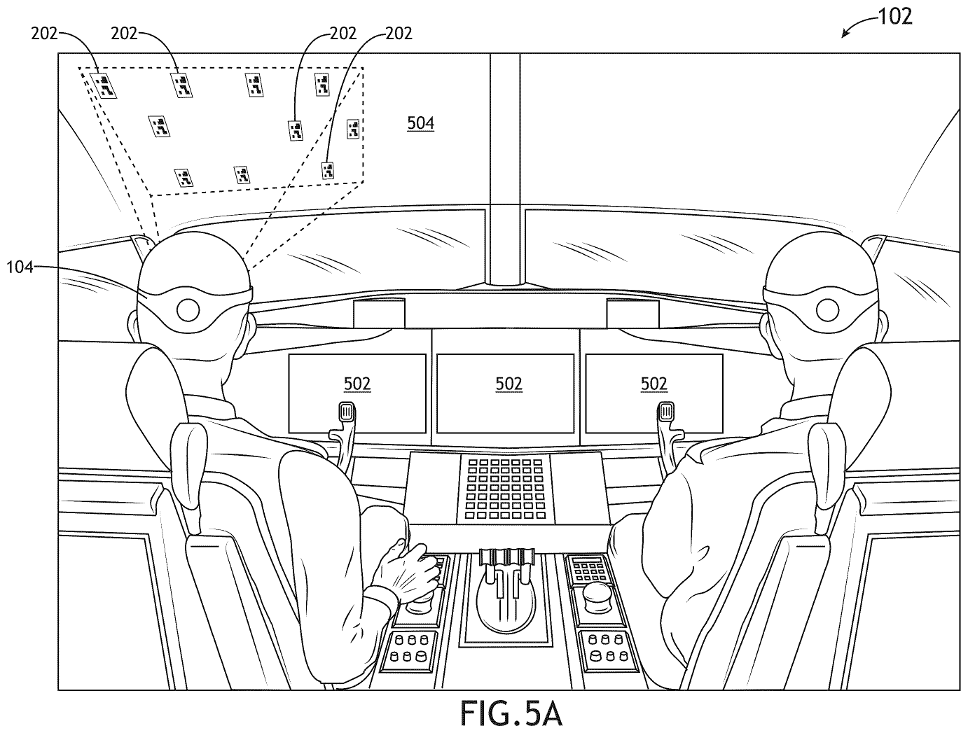

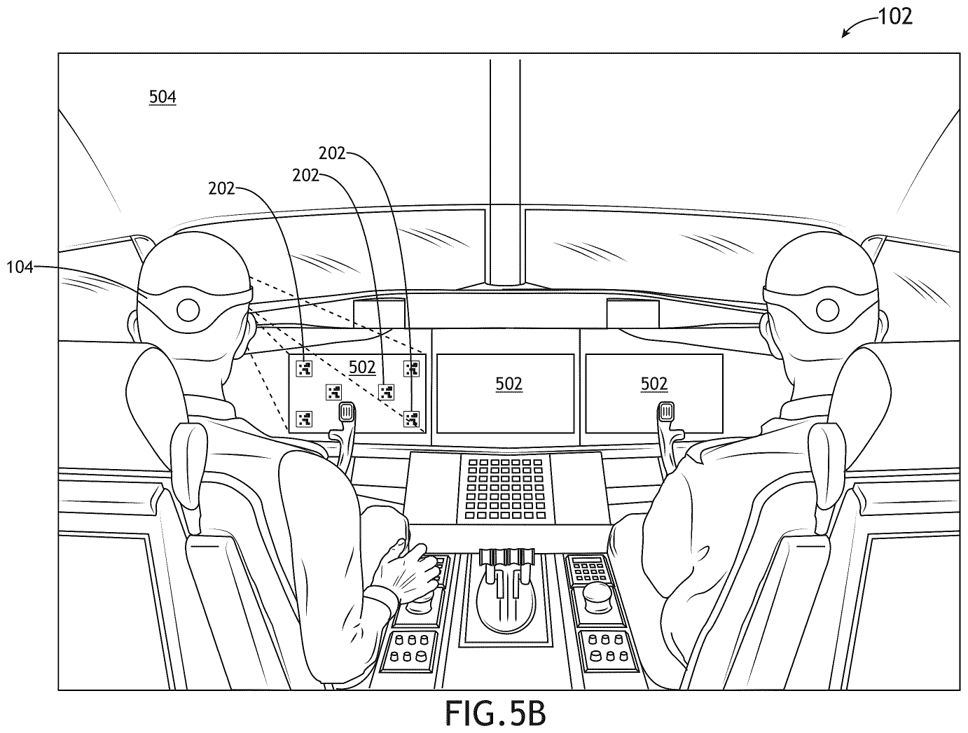

As shown in FIGS. 2, 5A, and 5B, each of the cockpit reference fiducials (e.g., imperceptible cockpit reference fiducials 202) may be located at a different location within the vehicle cockpit (e.g., aircraft cockpit 102). At least two of the cockpit reference fiducials may be imperceptible cockpit reference fiducials 202. The imperceptible cockpit reference fiducials 202 may be imperceptible to a naked eye of a user in the vehicle cockpit (e.g., aircraft cockpit 102).

For example, as shown in FIG. 5A some or all of the imperceptible cockpit reference fiducials 202 may be located on structures (e.g., ceiling 504, on at least one avionics console, at least one HDD 502, and/or on at least one overhead switch panel) within the aircraft cockpit 102.

For example, as shown in FIG. 5B some or all of the imperceptible cockpit reference fiducials 202 may be imperceptible HDD cockpit reference fiducials displayed by the at least one HDD 502. The at least one HDD 502 may be configured to imperceptibly display the at least one imperceptible HDD cockpit reference fiducial.

For example, the at least one HDD 502 may be configured to imperceptibly display the at least one imperceptible HDD cockpit reference fiducial by intermittently displaying a frame of the at least one imperceptible HDD cockpit reference fiducial. For example, the at least one imperceptible HDD cockpit reference fiducial may be displayed within a visible spectrum of light and/or within an invisible spectrum (e.g., the ultraviolet (UV), IR, short-wave infrared (SWIR), and/or NIR spectrum).

For example, the at least one HDD 502 may be configured to imperceptibly display the at least one imperceptible HDD cockpit reference fiducial by displaying the at least one imperceptible HDD cockpit reference fiducial within an invisible spectrum (e.g., the ultraviolet (UV), IR, short-wave infrared (SWIR), and/or NIR spectrum). For example, the at least one optical sensor 204 may be configured to: capture the images of the at least one imperceptible HDD cockpit reference fiducial within the invisible spectrum (e.g., the ultraviolet (UV), IR, short-wave infrared (SWIR), and/or NIR spectrum). For example, the imperceptible cockpit reference fiducials 202 may further comprise at least one imperceptible coating cockpit reference fiducial applied to a surface (e.g., the ceiling 504) of the vehicle cockpit, wherein the at least one imperceptible coating cockpit reference fiducial is configured to reflect and/or emit light in the invisible spectrum (e.g., the ultraviolet (UV), IR, short-wave infrared (SWIR), and/or NIR spectrum).

In some embodiments, the imperceptible cockpit reference fiducials 202 may include at least one imperceptible coating cockpit reference fiducial applied to a surface (e.g., the ceiling 504) of the vehicle cockpit (e.g., aircraft cockpit 102), wherein the at least one imperceptible coating cockpit reference fiducial is configured to reflect and/or emit light in the invisible spectrum (e.g., the ultraviolet (UV), IR, short-wave infrared (SWIR), and/or NIR spectrum). For example, the at least one optical sensor 204 may be configured to: capture the images of the at least one imperceptible coating cockpit reference fiducial within the invisible spectrum (e.g., the ultraviolet (UV), IR, short-wave infrared (SWIR), and/or NIR spectrum). In some embodiments, the at least one imperceptible coating cockpit reference fiducial is a paint and is color matched to paint surrounding the at least one coating imperceptible cockpit reference fiducial. In some embodiments, the at least one imperceptible coating cockpit reference fiducial is a transparent coating.

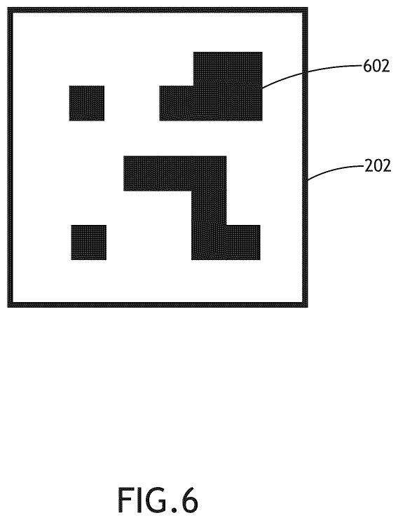

As shown in FIG. 6, each of one or more of the imperceptible cockpit reference fiducials comprises an imperceptible pattern 602 being imperceptible to the naked eye of the user in the vehicle cockpit. In some embodiments, each of the imperceptible patterns 602 may be unique among all other of the imperceptible patterns 602, wherein each of the imperceptible patterns 602 is associated with a specific location within the vehicle cockpit such that the at least one processor is configured to determine a location of a given imperceptible pattern 602 of the imperceptible patterns 602 based at least on a unique pattern of the given imperceptible pattern 602.

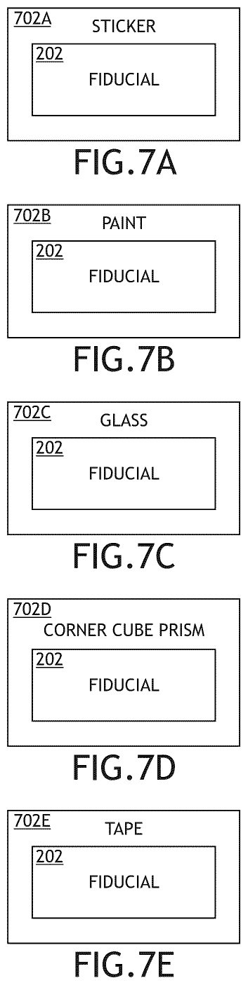

As shown in FIGS. 7A, 7B, 7C, 7D, and 7E, one or more of the imperceptible cockpit reference fiducials 202 may be applied to or embedded within a sticker 702A, tape 702E, paint 702B, glass 702C, and/or a corner cube prism 702D, wherein the at least one imperceptible coating cockpit reference fiducial is configured to reflect and/or emit light in the invisible spectrum (e.g., the ultraviolet (UV), IR, short-wave infrared (SWIR), and/or NIR spectrum). In some embodiments, one of ordinary skill in the art may use materials known to be transparent for visible light but reflective or absorptive in UV, IR, SWIR, and/or NIR light (e.g., for stickers, paint, glass, and/or corner cubes,) to create a fiducial that is highly visible to an IR and/or NIR system but invisible or reduced visibility in the visible spectrum, such that the fiducial blends into the cockpit for a more aesthetic and less distracting (e.g., to a pilot) installation.

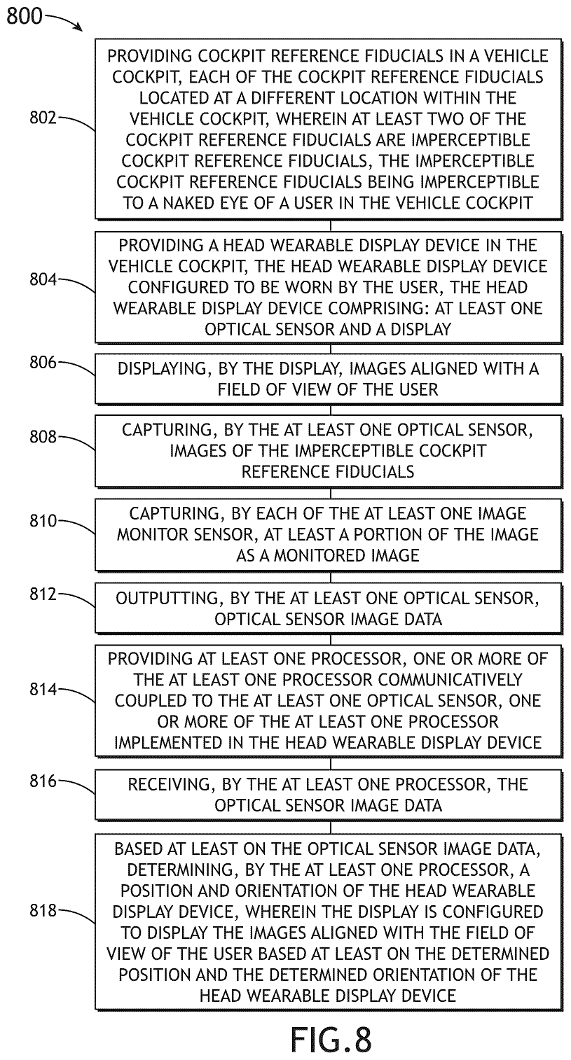

Referring now to FIG. 8, an exemplary embodiment of a method 800 according to the inventive concepts disclosed herein may include one or more of the following steps. Additionally, for example, some embodiments may include performing one or more instances of the method 800 iteratively, concurrently, and/or sequentially. Additionally, for example, at least some of the steps of the method 800 may be performed in parallel and/or concurrently. Additionally, in some embodiments, at least some of the steps of the method 800 may be performed non-sequentially. Additionally, in some embodiments, at least some of the steps of the method 800 may be performed in sub-steps of providing various components.

A step 802 may include providing cockpit reference fiducials in a vehicle cockpit, each of the cockpit reference fiducials located at a different location within the vehicle cockpit, wherein at least two of the cockpit reference fiducials are imperceptible cockpit reference fiducials, the imperceptible cockpit reference fiducials being imperceptible to a naked eye of a user in the vehicle cockpit (e.g., wherein the imperceptible cockpit reference fiducials may be transparent quick response (QR) codes).

A step 804 may include providing a head wearable display device in the vehicle cockpit, the head wearable display device configured to be worn by the user, the head wearable display device comprising: at least one optical sensor and a display.

A step 806 may include displaying, by the display, images aligned with a field of view of the user.

A step 808 may include capturing, by the at least one optical sensor, images of the imperceptible cockpit reference fiducials.

A step 810 may include outputting, by the at least one optical sensor, optical sensor image data.

A step 812 may include providing at least one processor, one or more of the at least one processor communicatively coupled to the at least one optical sensor, one or more of the at least one processor implemented in the head wearable display device.

A step 814 may include receiving, by the at least one processor, the optical sensor image data.

A step 816 may include based at least on the optical sensor image data, determining, by the at least one processor, a position and orientation of the head wearable display device, wherein the display is configured to display the images aligned with the field of view of the user based at least on the determined position and the determined orientation of the head wearable display device.

A step 818 may include based at least on the monitored image data, determining, by the at least one processor, whether the waveguide display displayed the image correctly.

Further, the method 800 may include any of the operations disclosed throughout.

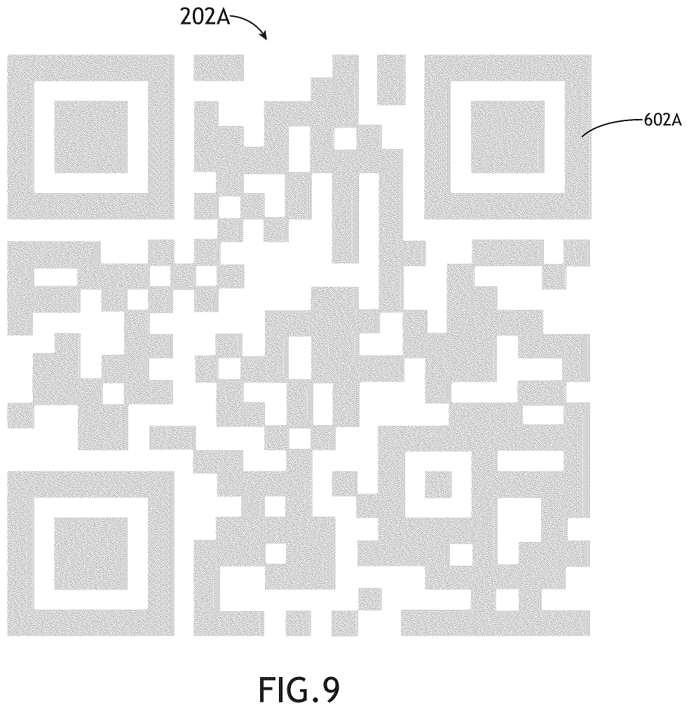

As shown in FIG. 9, each of one or more of the imperceptible cockpit reference fiducials may be a transparent quick response (QR) code 202A having an imperceptible (e.g., invisible) pattern 602A being imperceptible to the naked eye of the user in the vehicle cockpit. In some embodiments, each of the imperceptible patterns 602A may be unique among all other of the imperceptible patterns 602A, wherein each of the imperceptible patterns 602A is associated with a specific location within the vehicle cockpit such that the at least one processor is configured to determine a location of a given imperceptible pattern 602A of the imperceptible patterns 602A based at least on a unique pattern of the given imperceptible pattern 602.

In some embodiments, each transparent QR code 202A may be printed directly on a surface, such as cockpit windows, displays or head wearable display devices. In some embodiments, transparent QR codes 202A may eliminate the use of vision blocking stickers in a pilot's field of view. In some embodiments, transparent QR codes 202A may eliminate a potential for sticker adhesive to be degraded by ultraviolet (UV) light exposure, which can lead to stickers falling off a surface. Some embodiments may provide an improved field of view by eliminating the use of vision blocking stickers.

In some embodiments, the system may include a vehicle cockpit and at least one processor (e.g., 108 and/or 122). The vehicle cockpit includes cockpit reference fiducials and a head wearable display (HWD) device 104. Each of the cockpit reference fiducials are located at a different location within the vehicle cockpit. At least two of the cockpit reference fiducials are imperceptible cockpit reference fiducials 202. The imperceptible cockpit reference fiducials are imperceptible to a naked eye of a user in the vehicle cockpit, wherein the imperceptible cockpit reference fiducials are transparent quick response (QR) codes 202. The head wearable display device 104 is configured to be worn by the user. The HWD device 104 includes a display configured to display images aligned with a field of view of the user and an optical sensor 204 configured to: capture images of the imperceptible cockpit reference fiducials 202; and output optical sensor image data. One or more of the at least one processor is communicatively coupled to the optical sensor. One or more of the at least one processor (e.g., 108 and/or 122) is implemented in the HWD device. The at least one processor (e.g., 108 and/or 122) is configured to: receive the optical sensor image data; and based at least on the optical sensor image data, determine a position and orientation of the head wearable display device 104. The display (e.g., 110) is configured to display the images aligned with the field of view of the user based at least on the determined position and the determined orientation of the head wearable display device 104.

In some embodiments, the transparent QR codes 202A have transparent graphene ink. In some embodiments, the graphene ink may be produced by Haydale based in the United Kingdom, such as SynerG Conductive Ink & Paste P080050, SynerG Conductive Ink & Paste F070018, SynerG Conductive Ink & Paste 1073016, SynerG Conductive Ink & Paste 1073060, and/or SynerG Conductive Ink & Paste 1073065 (technical data sheets, which are concurrently submitted in an Information Disclosure Statement, for such exemplary transparent graphene inks, are incorporated by reference in their entirety). In some embodiments, the transparent QR codes 202A are printed directly on a surface (e.g., a cockpit structure (e.g., glass cockpit windows or park viewing windows), a display (e.g., 110 or 502), or the head wearable display device 104 (e.g., on a visor or a safety shield)). For example, the transparent QR codes 202A may be printed, such as by additive manufacturing via fused deposition manufacturing (FDM) or via aerosol jetting or by screen printing. In some embodiments, the transparent QR codes 202A are detectable using an invisible spectrum of light. In some embodiments, the transparent graphene ink is transparent photoluminescent graphene ink configured to emit light to illuminate the transparent QR codes 202A. In some embodiments, the transparent photoluminescent graphene ink configured to emit infrared (IR) light to invisibly illuminate the transparent QR codes 202A. In some embodiments, the transparent graphene ink is optically transparent in a visible spectrum and optically opaque in an infrared (IR) spectrum.

In some embodiments, the transparent QR codes 202A may be applied to a surface as part of a transparent sticker.

In some embodiments, the at least one optical sensor 204 is configured to: capture the images of the at least one imperceptible cockpit reference fiducial 202 within the invisible spectrum.

In some embodiments, the system may include reference fiducials, each of the reference fiducials located at a different location within an environment (e.g., a vehicle cockpit, a room equipped with a virtual reality (VR), augmented reality (AR), and/or mixed reality (MR) setup (such as for VR, AR, and/or MR video games, experiences, or simulation training (e.g., soldier training))). At least two of the reference fiducials are imperceptible reference fiducials 202. The imperceptible reference fiducials 202 being imperceptible to a naked eye of a user in the environment, wherein the imperceptible reference fiducials 202 are transparent quick response (QR) codes 202A. The system may further include a head wearable display device 104 configured to be worn by the user, the head wearable display device 104 comprising a display (e.g., 110) and at least one optical sensor (e.g., 204). The display (e.g., 110) is configured to display images aligned with a field of view of the user. The at least one optical sensor 204 is configured to: capture images of the imperceptible reference fiducials 202; and output optical sensor image data. The system may further include at least one processor (e.g., 108 and/or 122), one or more of the at least one processor (e.g., 108 and/or 122) communicatively coupled to the at least one optical sensor 204, one or more of the at least one processor implemented in the head wearable display device 104. The at least one processor (e.g., 108 and/or 122) is configured to: receive the optical sensor image data; and based at least on the optical sensor image data, determine a position and orientation of the head wearable display device 104. The display (e.g., 110) is configured to display the images aligned with the field of view of the user based at least on the determined position and the determined orientation of the head wearable display device 104.

In some embodiments, the transparent QR codes 202A may be used as watermarks on paper, plastic or other substrates. In some embodiments, the transparent QR codes 202A may be used for hardware counterfeit avoidance by applying the transparent QR codes 202A to original equipment manufacturer (OEM) parts to verify parts have not been counterfeited. In some embodiments, the transparent QR codes 202A may be used for virtual reality gaming set applications. In some embodiments, the transparent QR codes 202A may be used for imperceptibly info-tagging sites, such as National Park windows, by applying the transparent QR codes 202A to a window to provide information about what a person is viewing (e.g., height of a mountain, depth of a valley, first person to climb a mountain, an age of a fossil, etc.).

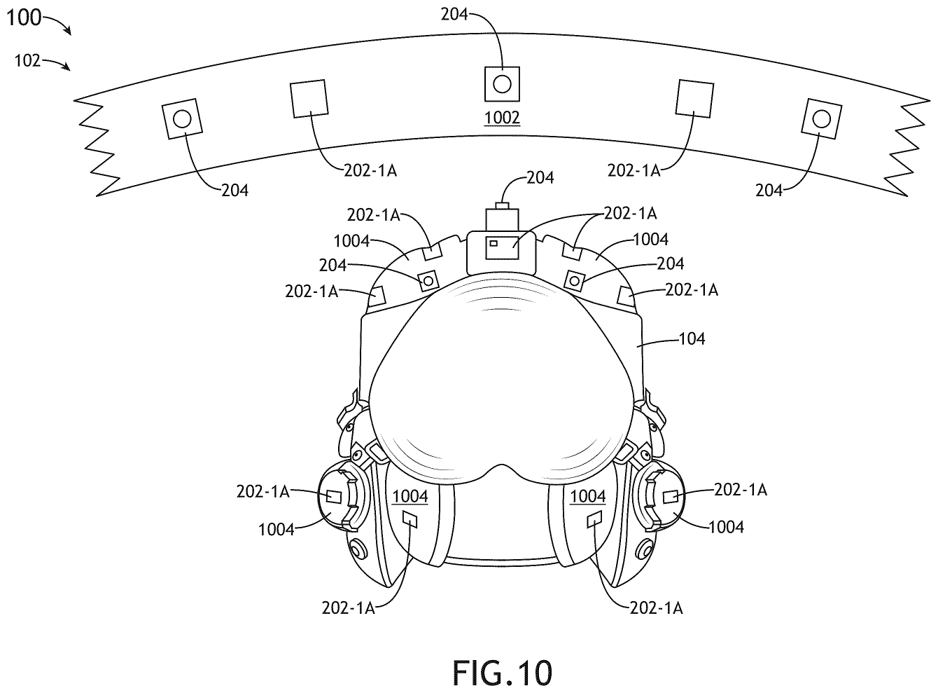

Referring generally now to FIGS. 10-12, as well as aforementioned FIGS. 1-9, exemplary embodiments of a system according to the inventive concepts disclosed herein are depicted. The system may be implemented as any suitable system having an environment, such as at least one vehicle (e.g., having an environment of a cockpit; e.g., an aircraft 100 having an aircraft cockpit 102, a spacecraft, an automobile having an automobile cockpit, a watercraft, a submarine, or a train) or a room equipped with a virtual reality (VR), augmented reality (AR), and/or mixed reality (MR) setup (such as for VR, AR, and/or MR video games, experiences, or simulation training (e.g., soldier training))).

In some embodiments, the system may include reference fiducials (e.g., at least one imperceptible reference fiducial 202 (e.g., at least one imperceptible cockpit reference fiducial 202), at least one electroluminescent reference fiducial 202-1A (e.g., at least one electroluminescent cockpit reference fiducial), at least one opaque reference fiducial, and/or at least one at least partially transparent reference fiducial). For example, each of the reference fiducials may be located at a different location within an environment (e.g., a vehicle cockpit (e.g., 102) or a room). For example, at least one of the reference fiducials may be at least one electroluminescent reference fiducial 202-1A.

In some embodiments, the system may include at least one head wearable display (HWD) device 104 configured to be worn by the user. For example, the HWD device 104 may include a display (e.g., 110), which may be configured to display images aligned with a field of view of the user.

In some embodiments, the system may include at least one optical sensor 204. The at least one optical sensor 204 may be configured to capture images of one or more of the at least one electroluminescent reference fiducial 202-1A and/or to output optical sensor image data corresponding to the captured images.

In some embodiments, the one or more of the at least one electroluminescent reference fiducial 202-1A may be located on at least one of at least one exterior surface 1004 (e.g., on a waveguide 114, a visor, or elsewhere on the HWD device 104) of the head wearable display device 104 within the environment (e.g., a vehicle cockpit (e.g., 102) or a room) or on at least one surface (e.g., a cockpit surface 1002, such as a on at least one ceiling 502, on at least one windshield, on at least one cockpit door, on at least one wall, and/or on at least one display 504) within the environment, wherein each of the at least one surface is not one of the at least one exterior surface 1004 of the head wearable display device 104. For example, each of any or all of the at least one electroluminescent reference fiducial 202-1A may include a transparent quick response (QR) code (e.g., 202A or electroluminescent QR code 202B), said reference fiducial 202-1A (e.g., including a transparent quick response (QR) code (e.g., 202A or electroluminescent QR code 202B)) located on at least one exterior surface 1004 (e.g., on a waveguide 114, a visor, or elsewhere on the HWD device 104) of the head wearable display device 104 within the environment (e.g., a vehicle cockpit (e.g., 102) or a room); and/or each of any or all of the at least one electroluminescent reference fiducial 202-1A may include a transparent quick response (QR) code (e.g., 202A or electroluminescent QR code 202B), said reference fiducial 202-1A (e.g., including a transparent quick response (QR) code (e.g., 202A or electroluminescent QR code 202B)) located on at least one surface (e.g., a cockpit surface 1002, such as a on at least one ceiling 502, on at least one windshield, on at least one cockpit door, on at least one wall, and/or on at least one display 504) within the environment.

In some embodiments, one or more of the at least one optical sensor 204 may be located in, within, and/or on at least one of the head wearable display device 104 within the environment or one or more surfaces (e.g., a cockpit surface 1002, such as a on at least one ceiling 502, on at least one windshield, on at least one cockpit door, on at least one wall, and/or on at least one display 504) within the environment, wherein each of the one or more surfaces is not one of the at least one exterior surface 1004 of the head wearable display device 104.

In some embodiments, the one or more of the at least one electroluminescent reference fiducial 202-1A may be located on the at least one exterior surface 1004 of the head wearable display device 104 within the vehicle cockpit, and/or the one or more of the at least one optical sensor 204 may be located in, within, and/or on the one or more surfaces within the environment (e.g., a room or a vehicle cockpit).

In some embodiments, the one or more of the at least one electroluminescent cockpit reference fiducial may be located on the at least one surface within the environment (e.g., the room or the vehicle cockpit), and/or the one or more of the at least one optical sensor 204 may be located in, within, and/or on the head wearable display device 104 within the environment.

In some embodiments, the system may include at least one processor (e.g., at least one processor 108, at least one processor 122, at least one processor 206, at least one processor 302, and/or at least one processor 402). For example, one or more of the at least one processor may be communicatively coupled to the at least one optical sensor 204. For example, at least one of the at least one processor may be implemented in and/or on the head wearable display device 104. For example, the at least one processor may be configured to receive the optical sensor image data; and/or based at least on the optical sensor image data, determine a position and orientation of the head wearable display device 104.

In some embodiments, the display (e.g., 110) may be configured to display the images aligned with the field of view of the user based at least on the determined position and the determined orientation of the head wearable display device 104.

In some embodiments, the one or more of the at least one electroluminescent reference fiducial 202-1A is configured to emit light at least one of within the visible spectrum or within the invisible spectrum. In some embodiments, at least one of the one or more of the at least one electroluminescent reference fiducial 202-1A may be configured at least to emit light at least within the infrared (IR) spectrum. For example, at least one of the one or more of the at least one electroluminescent reference fiducial 202-1A may be configured at least to emit light at least one of within the infrared (IR) spectrum or the near infrared (NIR) spectrum.

In some embodiments, each of the one or more of the at least one electroluminescent reference fiducial 202-1A may include at least one electroluminescent ink 1202 (e.g., electroluminescent inks manufactured and sold by Saralon GmbH, Lothringer Strasse 11—Hall L, 09120 Chemnitz, Germany, such as solvent-based electroluminescent ink(s) (e.g., having product model numbers of Saral BluePhosphorL 800, Saral GreenPhosphorL 800, Saral OrangePhosphorL 800, and/or) Saral WhitePhosphorL 800) and/or ultraviolet (UV)-curable electroluminescent ink(s) (e.g., having product model numbers of Saral UVBluePhosphorL 800, Saral UVGreenPhosphorL 800, Saral UVOrangePhosphorL 800, and/or Saral UVWhitePhosphorL 800)). In some embodiments, each of said at least one electroluminescent ink 1202 may be or may include a phosphor electroluminescent chemical(s). In some embodiments, each of the one or more of the at least one electroluminescent reference fiducial 202-1A may further include at least one piezoelectric energy harvester 1204, each of which may be configured to provide at least one alternating current (AC) to power electroluminescence of each of said at least one electroluminescent ink 1202. In some embodiments, each of said at least one piezoelectric energy harvester 1024 may be composed at least in part of a polyvinylidene fluoride (PVDF) material(s).

In some embodiments, each of one or more of the at least one electroluminescent reference fiducial 202-1A may include an adhesive on at least one side of said electroluminescent reference fiducial 202-1A of the one or more of the at least one electroluminescent reference fiducial 202-1A.

In some embodiments, each of the one or more of the at least one electroluminescent reference fiducial 202-1A may be implemented as at least one of a sticker or tape.

In some embodiments, the environment is a vehicle cockpit, wherein the reference fiducials are cockpit reference fiducials, wherein the at least one electroluminescent reference fiducial 20-14A is at least one electroluminescent cockpit reference fiducial.

In some embodiments, each of the one or more of the at least one electroluminescent cockpit reference fiducial may have at least two regions (e.g., at least two of 1102A, 1102B, 1102C, 1102D, and/or 1102E) including a first region 1102A, 1102B, 1102C, 1102D, or 1102E and a second region 1102A, 1102B, 1102C, 1102D, or 1102E. For example, the first region 1102A, 1102B, 1102C, 1102D, or 1102E of said electroluminescent cockpit reference fiducial may be configured to emit light within a first band of the electromagnetic spectrum, and/or said second region 1102A, 1102B, 1102C, 1102D, or 1102E of said electroluminescent cockpit reference fiducial may be configured to emit light within a second band of the electromagnetic spectrum. For example, the first band and the second band may be different (e.g., non-overlapping, overlapping (e.g., partially overlapping), or enveloping). In some embodiments, said first region 1102A, 1102B, 1102C, 1102D, or 1102E of said electroluminescent cockpit reference fiducial may be configured to emit light within said first band of the invisible spectrum, and/or said second region 1102A, 1102B, 1102C, 1102D, or 1102E of said electroluminescent cockpit reference fiducial may be configured to emit light within said second band of the invisible spectrum. In some embodiments, said first region 1102A, 1102B, 1102C, 1102D, or 1102E of said electroluminescent cockpit reference fiducial may be configured to emit light within said first band of the infrared (e.g., NIR and/or SWIR) spectrum, and/or said second region 1102A, 1102B, 1102C, 1102D, or 1102E of said electroluminescent cockpit reference fiducial may be configured to emit light within said second band of the infrared (e.g., NIR and/or SWIR) spectrum. In some embodiments, said electroluminescent cockpit reference fiducial may include a transparent quick response (QR) code (e.g., 202A or electroluminescent QR code 202B), and/or each of at least one of said first region 1102A, 1102B, 1102C, 1102D, or 1102E or said second region 1102A, 1102B, 1102C, 1102D, or 1102E may be implemented as at least a portion of said transparent QR code (e.g., 202A or electroluminescent QR code 202B). In some embodiments, the one or more of the at least one electroluminescent cockpit reference fiducial having said at least two regions (e.g., two of 1102A, 1102B, 1102C, 1102D, and 1102E) may be at least two reference fiducials of at least two electroluminescent cockpit reference fiducials. For example, the at least two reference fiducials of the at least two electroluminescent cockpit reference fiducials may include a first electroluminescent cockpit reference fiducial and a second electroluminescent cockpit reference fiducial. For example, each of the first and second electroluminescent cockpit reference fiducials may have one of (a) a unique geometric arrangement of said first region 1102A, 1102B, 1102C, 1102D, or 1102E and said second region 1102A, 1102B, 1102C, 1102D, or 1102E, (b) a unique combined electromagnetic emission profile (e.g., a combined electromagnetic emission profile may refer to a profile of an electromagnetic frequency(ies) and/or a band(s) of frequencies collectively emitted by a given electroluminescent reference fiducial 202-1A) of said first region 1102A, 1102B, 1102C, 1102D, or 1102E and said second region 1102A, 1102B, 1102C, 1102D, or 1102E, or (c) a unique combination of (i) a geometric arrangement of said first region 1102A, 1102B, 1102C, 1102D, or 1102E and said second region 1102A, 1102B, 1102C, 1102D, or 1102E and (ii) a combined electromagnetic emission profile of said first region 1102A, 1102B, 1102C, 1102D, or 1102E and said second region 1102A, 1102B, 1102C, 1102D, or 1102E. In some embodiments, each of the first and second electroluminescent cockpit reference fiducials may include a transparent quick response (QR) code (e.g., 202A or electroluminescent QR code 202B) having said first region 1102A, 1102B, 1102C, 1102D, or 1102E and said second region 1102A, 1102B, 1102C, 1102D, or 1102E. In some embodiments, each of the first and second electroluminescent cockpit reference fiducials may be indicative of a known (e.g., installed and recorded) unique location in, on, and/or within (1) the at least one exterior surface 1004 of the head wearable display device 104 or (2) the one or more surfaces (e.g., of the vehicle cockpit) based at least on the one of (a) said unique geometric arrangement, (b) said unique combined electromagnetic emission profile, or (c) said unique combination.

In some embodiments, the at least one electroluminescent cockpit reference fiducial may be at least two electroluminescent reference fiducials including a first electroluminescent cockpit reference fiducial and a second electroluminescent cockpit reference fiducial. For example, the first electroluminescent cockpit reference fiducial may be configured to emit light within a first band of the electromagnetic spectrum (e.g., the infrared (e.g., NIR and/or SWIR) spectrum), and/or the second electroluminescent cockpit reference fiducial may be configured to emit light within a second band of the electromagnetic spectrum (e.g., the infrared (e.g., NIR and/or SWIR) spectrum). For example, each of the first band and second band may be at least partially within at least one of the near infrared (NIR) spectrum or the short-wave infrared (SWIR) spectrum. For example, the first band and the second band may be different.

In some embodiments, the one or more of the at least one electroluminescent cockpit reference fiducial may be transparent over the visible spectrum.

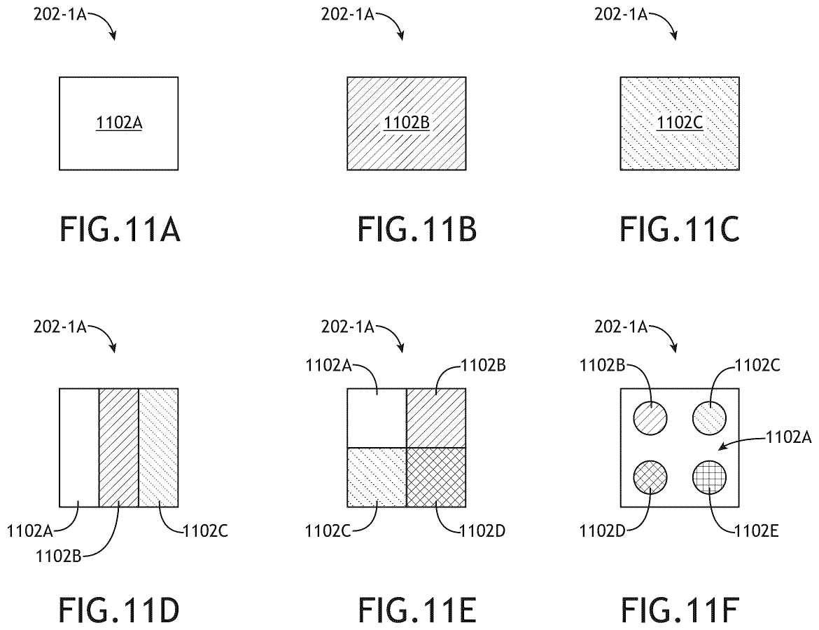

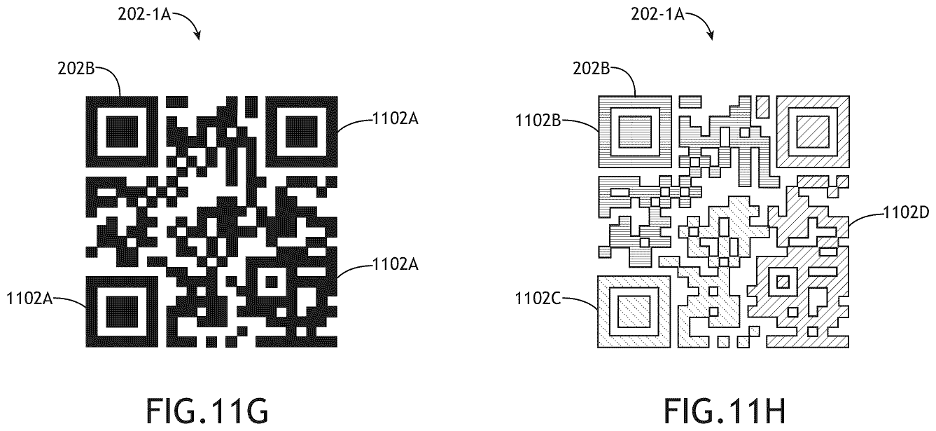

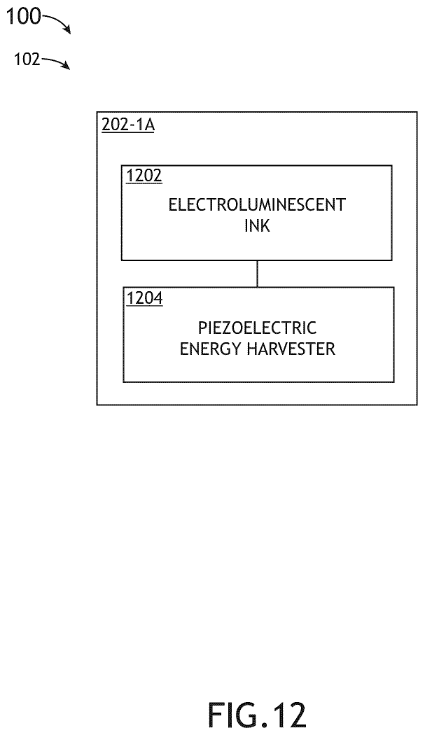

As shown in FIGS. 11A, 11B, 11C, 11D, 11E, 11F, 11G, 11H, and 12, some embodiments may include an electroluminescent reference fiducial 202-1A.

For example, as shown in FIGS. 11A-H, each (e.g., with respect to one the electroluminescent reference fiducials 202-1A of FIGS. 11A-H compared to others of the electroluminescent reference fiducials 202-1A of other FIGS. 11A-H) of the electroluminescent reference fiducials 202-1A have a unique geometric arrangement of said first region 1102A, 1102B, 1102C, 1102D, or 1102E and said second region 1102A, 1102B, 1102C, 1102D, or 1102E. Further, each of the regions 1102A, 1102B, 1102C, 1102D, and 1102E of the electroluminescent reference fiducial 202-1A may be configured to emit light within a different band of the electromagnetic spectrum (e.g., the visible spectrum and/or the invisible spectrum (e.g., UV spectrum, the infrared spectrum (e.g., NIR and/or SWIR spectrum))). For example, the region 1102A may be configured to emit within a first bandwidth (e.g., any suitable bandwidth size, such as 1 nm+/−0.5 nm, 10 nm+/−2 nm, 20 nm 5 nm, or 100 nm+/−20 nm) within the NIR spectrum, the region 1102B may be configured to emit within a second bandwidth (e.g., any suitable bandwidth size) within the NIR, the region 1102C may be configured to emit within a third bandwidth (e.g., any suitable bandwidth size) within the SWIR spectrum, the region 1102D may be configured to emit within a fourth bandwidth (e.g., any suitable bandwidth size) within the visible spectrum, the region 1102E may be configured to emit within a fifth bandwidth (e.g., any suitable bandwidth size) within the visible spectrum, and the region 1102E may be configured to emit within a sixth bandwidth (e.g., any suitable bandwidth size) within the UV spectrum. For example, each of the electroluminescent reference fiducials 202-1A may have a unique combined electromagnetic emission profile of the region(s) 1102A, 1102B, 1102C, 1102D, and/or 1102E of said electroluminescent reference fiducials 202-1A.

As shown in FIG. 12, in some embodiments, the electroluminescent reference fiducial 202-1A may include at least one electroluminescent ink 1202 (e.g., as described above) and at least one piezoelectric energy harvester 1204 (e.g., as described above) configured to provide at least one alternating current (AC) to power electroluminescence of each of the at least one electroluminescent ink 1202.

For example, each of the at least one piezoelectric energy harvester 1204 may at least be composed of a polyvinylidene fluoride (PVDF) material(s). For example, PVDF is a piezoelectric material which generates voltage when pressure or strain is applied. This material can be applied to a substrate using additive manufacturing. When a PVDF substrate is flexed or vibrated, the movement causes the PVDF material to generate voltage. For example, a movement in one direction creates a positive voltage, and a movement in an opposite direction creates a negative voltage (or vice versa), which is referred to as alternating voltage or alternating current (AC). Electroluminescence may be powered by alternating current (AC) (but currently not direct current (DC)). When AC electricity is applied, electrons in the ink's phosphor are knocked to a higher energy level or orbital. When these electrons move back to their original energy level, they emit light particles called photons. At the point when the electrons release their extra energy and return to their previous state they will release photons, causing the phosphor to glow or electroluminesce. Some embodiments may include use of an NIR camera (e.g., including an NIR optical sensor), as currently NIR optical sensors performs well during daytime solar irradiation; additionally, such NIR radiation has wavelengths in the night vision imaging system (NVIS)-safe bands (which may be used in military cockpits, rotorcraft cockpits, and commercial cockpits).

Some embodiments may use additive manufacturing to apply clear electroluminescent ink to fabricate electroluminescing QR codes, which can be printed onto clear adhesive-backed substrates (e.g., as stickers and/or tape) or directly printed onto surfaces of an environment, such as cockpit windows, displays, HWD devices, or other surfaces.

Some embodiments may allow for vision blocking stickers to be removed and/or omitted from a pilot's field of view. Some embodiments may allow QR codes to be placed in dimly lit and/or dark locations that may have been previously unusable. Some embodiments may enables switching IR camera(s) to an optical camera configured to capture light in the visible spectrum. In some embodiments, different QR codes in different locations of the environment (e.g., the cockpit or room) can be different colors or different bands of invisible spectrum. Some embodiments may allow the QR codes to be placed on the pilot helmet and/or the heavy camera to be mounted inside the cockpit.

In some embodiments QR codes can be applied to parts that previously required intrusive, light blocking markings. Some embodiments may allow for a reduced-weight HWD device (e.g., a helmet) by allowing optical sensors to be located on cockpit surfaces rather than on the HWD device, which can improve pilot stamina. Some embodiments address long-felt needs within the industry, such as long-felt, on-going customer complaints about field of view obstruction caused by reference fiducials. Some embodiments allow for swapping the camera from the helmet and QR codes from the cockpit, to reduce the weight of the HWD device (e.g., the helmet).

In some embodiments, at least one processor could be programmed with software to detect and read something other than QR codes. For example, in a simple implementation, a constellation of NIR electroluminescing reference fiducials known to have a set, installation physical arrangement and relation, and a NIR optical sensor may detect that constellation in 3D space, and the at least one processor may determine relative head positioning accordingly. For example, Richer fiducials, like QR codes, can provide a reliable “handshake” with the camera and enable increasingly more sophisticated determination of the accuracy and reliability of a head angle estimation, and therefore may lead to higher design assurance of the system.

As will be appreciated from the above, embodiments of the inventive concepts disclosed herein may be directed to a method, an electroluminescent reference fiducial, and a system including at least one electroluminescent reference fiducial, which may be used for head and/or pose tracking of a head wearable display (HWD) device.

As used throughout and as would be appreciated by those skilled in the art, “at least one non-transitory computer-readable medium” may refer to as at least one non-transitory computer-readable medium (e.g., e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system, comprising:
reference fiducials, each of the reference fiducials located at a different location within an environment, wherein at least one of the reference fiducials is at least one electroluminescent reference fiducial;
a head wearable display device configured to be worn by a user, the head wearable display device comprising:
a display configured to display images aligned with a field of view of the user; and
at least one optical sensor, the at least one optical sensor configured to:
capture images of one or more of the at least one electroluminescent reference fiducial; and
output optical sensor image data corresponding to the captured images;
wherein the one or more of the at least one electroluminescent reference fiducial is located on at least one of at least one exterior surface of the head wearable display device within the environment or on at least one surface within the environment, each of the at least one surface not being one of the at least one exterior surface of the head wearable display device;
wherein one or more of the at least one optical sensor is located in, within, and/or on at least one of the head wearable display device within the environment or one or more surfaces within the environment, each of the one or more surfaces not being one of the at least one exterior surface of the head wearable display device; and
at least one processor, one or more of the at least one processor communicatively coupled to the at least one optical sensor, at least one of the at least one processor implemented in and/or on the head wearable display device, the at least one processor configured to:
receive the optical sensor image data; and
based at least on the optical sensor image data, determine a position and orientation of the head wearable display device,
wherein the display is configured to display the images aligned with the field of view of the user based at least on the determined position and the determined orientation of the head wearable display device.

2. The system of claim 1, wherein the one or more of the at least one electroluminescent reference fiducial is configured to emit light at least one of within the visible spectrum or within the invisible spectrum.

3. The system of claim 3, wherein at least one of the one or more of the at least one electroluminescent reference fiducial is configured at least to emit light at least one of within the infrared (IR) spectrum or the near infrared (NIR) spectrum.

4. The system of claim 1, wherein the environment is a vehicle cockpit, wherein the reference fiducials are cockpit reference fiducials, wherein the at least one electroluminescent reference fiducial is at least one electroluminescent cockpit reference fiducial.

5. The system of claim 4, wherein each of the one or more of the at least one electroluminescent cockpit reference fiducial has at least two regions including a first region and a second region, said first region of said electroluminescent cockpit reference fiducial being configured to emit light within a first band of the electromagnetic spectrum, said second region of said electroluminescent cockpit reference fiducial being configured to emit light within a second band of the electromagnetic spectrum, the first band and the second band being different.

6. The system of claim 5, wherein said first band and said second band are non-overlapping.

7. The system of claim 5, wherein said first region of said electroluminescent cockpit reference fiducial is configured to emit light within said first band of the invisible spectrum, said second region of said electroluminescent cockpit reference fiducial being configured to emit light within said second band of the invisible spectrum.

8. The system of claim 7, wherein said first region of said electroluminescent cockpit reference fiducial is configured to emit light within said first band of the infrared spectrum, said second region of said electroluminescent cockpit reference fiducial being configured to emit light within said second band of the infrared spectrum.

9. The system of claim 8, wherein said electroluminescent cockpit reference fiducial includes a transparent quick response (QR) code, wherein each of at least one of said first region or said second region is implemented as at least a portion of said transparent QR code.

10. The system of claim 8, wherein the one or more of the at least one electroluminescent cockpit reference fiducial having said at least two regions is at least two reference fiducials of at least two electroluminescent cockpit reference fiducials, wherein the at least two reference fiducials of the at least two electroluminescent cockpit reference fiducials includes a first electroluminescent cockpit reference fiducial and a second electroluminescent cockpit reference fiducial, wherein each of the first and second electroluminescent cockpit reference fiducials has one of (a) a unique geometric arrangement of said first region and said second region, (b) a unique combined electromagnetic emission profile of said first region and said second region, or (c) a unique combination of (i) a geometric arrangement of said first region and said second region and (ii) a combined electromagnetic emission profile of said first region and said second region.

11. The system of claim 10, wherein each of the first and second electroluminescent cockpit reference fiducials includes a transparent quick response (QR) code having said first region and said second region.

12. The system of claim 10, wherein each of the first and second electroluminescent cockpit reference fiducials is indicative of a known unique location in, on, and/or within (1) the at least one exterior surface of the head wearable display device or (2) the one or more surfaces based at least on the one of (a) said unique geometric arrangement, (b) said unique combined electromagnetic emission profile, or (c) said unique combination.

13. The system of claim 4, wherein the at least one electroluminescent cockpit reference fiducial is at least two electroluminescent reference fiducials including a first electroluminescent cockpit reference fiducial and a second electroluminescent cockpit reference fiducial, wherein the first electroluminescent cockpit reference fiducial is configured to emit light within a first band of the infrared spectrum, wherein the second electroluminescent cockpit reference fiducial is configured to emit light within a second band of the infrared spectrum, the first band and the second band being different.

14. The system of claim 13, wherein each of the first band and second band are at least partially within at least one of the near infrared (NIR) spectrum or short-wave infrared (SWIR) spectrum.

15. The system of claim 4, wherein the one or more of the at least one electroluminescent cockpit reference fiducial is transparent over the visible spectrum.

16. The system of claim 1, wherein each of the one or more of the at least one electroluminescent reference fiducial includes at least one electroluminescent ink.

17. The system of claim 16, wherein each of said at least one electroluminescent ink is or includes a phosphor electroluminescent chemical.

18. The system of claim 16, wherein each of the one or more of the at least one electroluminescent reference fiducial further includes at least one piezoelectric energy harvester configured to provide at least one alternating current (AC) to power electroluminescence of each of said at least one electroluminescent ink.

19. The system of claim 18, wherein each of said at least one piezoelectric energy harvester is at least composed of a polyvinylidene fluoride (PVDF) material.

20. An electroluminescent reference fiducial, comprising:
at least one electroluminescent ink; and
at least one piezoelectric energy harvester configured to provide at least one alternating current (AC) to power electroluminescence of each of the at least one electroluminescent ink.
